(19) United States
(12) Patent Application Publication
(10) Pub. No.: US 2001/0050111 A1
(43) Pub. Date: Dec. 13, 2001

(54) Flat pack encapsulated tubing package for well control cable

(76) Inventors: David H. Neuroth, Claremore, OK (US); Thomson Hall Wallace, Claremore, OK (US)

Correspondence Address: Shawn Hunter, Bracewell & Patterson, LLP, P.O. Box 61389, Houston, TX, 77208-1389, US

(21) Appl. No.: 09/901,283

(22) Filed: Jul. 9, 2001

Related U.S. Application Data
(63) Continuation-in-part of application No. 09/544,412, filed on Apr. 6, 2000.

(51) Int. Cl. F16L 11/22

(52) U.S. Cl. 138/116; 138/110; 138/134; 138/135

(57) ABSTRACT

Armored control cables are described. The control cables include fluid communication tubes and a metal armor layer that surrounds each of the fluid communication tubes. In one described embodiment, there are three fluid communication tubes that are disposed in a parallel relation and maintained in contact with one another. The metal armor layer is in contact with the outer surface of each of the three tubes and is preferable formed of spirally wound metal tape.

### CROSS-REFERENCE TO RELATED APPLICATION

This application is a continuation in part of U.S. Patent Application No. 09/544,412 filed Mar. 6, 2000.

### BACKGROUND OF THE INVENTION

1. Field of the Invention.

The present invention relates to cables of the type normally used to control or communicate with devices within a wellbore and the like. More particularly, the invention relates to particular configurations for such cable.

2. Description of the Related Art

Bundled control cables are used to transmit electrical power and/or signals as well as fluids between locations outside of a well bore and devices within the wellbore. Conventional control cables provide several fluid tubes and one or more instrument wire bundles. These control cables are typically covered by an extruded plastic or elastomeric sheath. Unfortunately, these arrangements provide very little protection for the tubes and wire bundles. Rocks, equipment, or other hazards can crush the control cable thereby rupturing the wires and tubes or making them inoperable.

Attempts have been made to provide a more protective package for the tubes and wire bundles. U.S. Pat. No. 4,262,703 describes control line that relies for protection upon wire ropes that laterally outlie the control lines. Unfortunately, this type of arrangement still permits narrow objects, or objects having narrow portions, to impact the control lines between the wire ropes. Also, the addition of the wire ropes adds width to the cable, thereby resulting in a cable that is bulky and unwieldy in use.

### SUMMARY OF THE INVENTION

The present invention provides improved control cable arrangements. In one preferred embodiment, parallel fluid transmission tubes are arranged in a side by side relation and then encapsulated in a protective outer metal armor. The tubes are maintained in contact with one another without the placement of elastomeric or plastic material that might preclude such contact. In addition, the armor is maintained in contact with the outer surface of each wire bundle and the tubing. No elastomeric or plastic jacket surrounds the metal armor so that the outer surface of the metal armor provides the outer surface of the control cable. In a preferred construction, the metal armor is formed of the spiral winds of a metal tape.

### BRIEF DESCRIPTION OF THE DRAWINGS

FIG. 1 is a schematic view of an exemplary wellbore with a fluid-activated packoff assembly, a pressure detector and submersible pump and incorporating a control cable constructed in accordance with the present invention.

FIG. 2 is a cross-sectional view of an exemplary control cable constructed in accordance with the present invention.

FIG. 3 is a cross-sectional view of an alternative control cable.

FIG. 4 is an external top view of the control cable shown in FIG. 3.

### DETAILED DESCRIPTION OF THE PREFERRED EMBODIMENTS

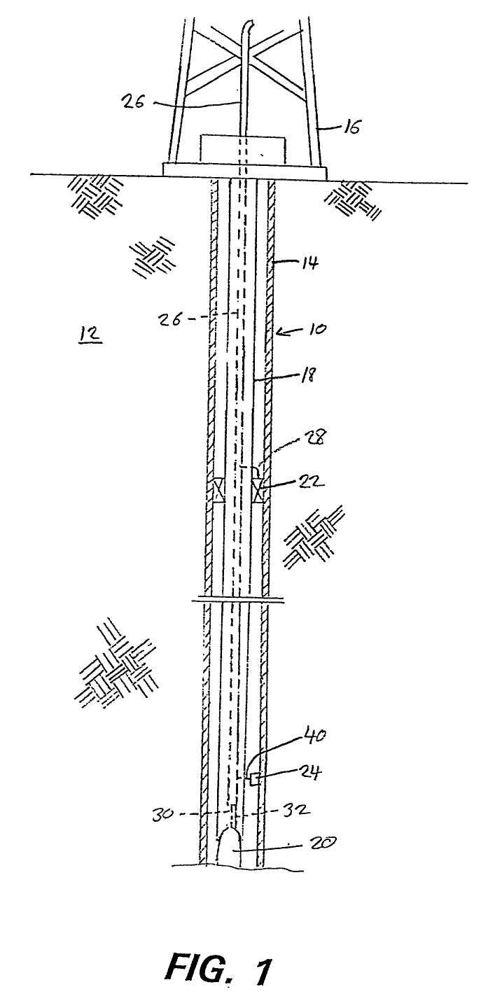

FIG. 1 is a schematic diagram illustrating an exemplary wellbore 10 that is drilled into the earth 12. The wellbore 10 is lined with casing 14 and extends downwardly from a wellhead 16 at the surface. Production tubing 18 is disposed within the wellbore 10 and is interconnected to a submersible fluid pump 20 at its lower end. The submersible pump 20 normally pumps a mixture of oil and brine from wells that have been drilled several thousand meters deep and under high temperatures and pressures. The wellbore 10 also includes a fluid actuated pack off assembly 22 of a type known in the art and a pressure sensor arrangement 24 that determines fluid pressure at a downhole location.

A control cable 26 extends downwardly into the wellbore 10 and is used to provide control or communications with the pack off assembly 22, fluid pump 20 and pressure sensor arrangement 24. It is pointed out that a pack off assembly, fluid pump and pressure sensor are used for the purposes of explanation only and that other components could as easily be employed. Cable 26 is preferably secured to the outer surface of the production tubing 18 using clamps or the like (not shown). Fluid sources, controllers, and other devices that are associated with the end of the cable 26 outside of the wellbore are not described here, as such are well understood in the art.

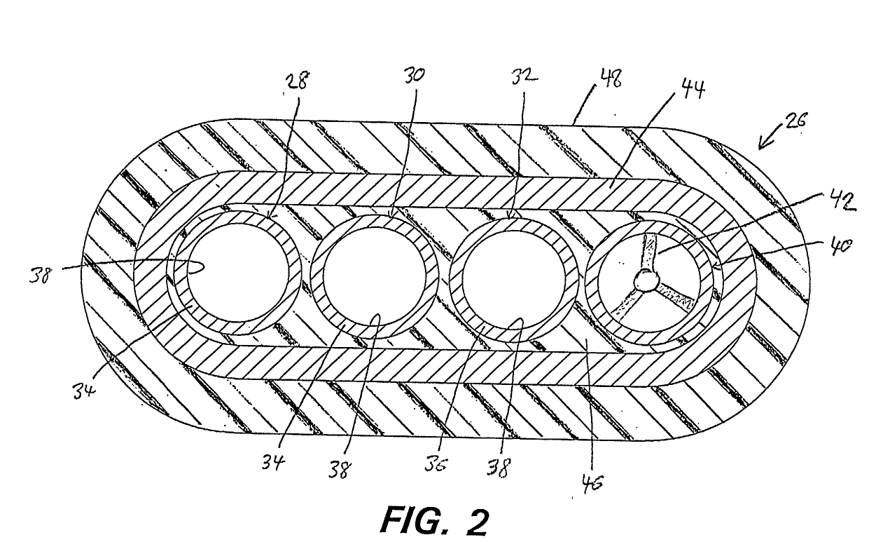

Referring now to FIG. 2 there is shown in cross-section an exemplary control cable 26. The cable 26 includes three fluid transmission tubes 28, 30, 32. Each of the tubes 28, 30, 32 has a cylindrical wall 35 that defines a flowbore 38 therethrough. The walls 34 of the tubs 28, 30, 32 are preferably fashioned from semi-flexible stainless steel. It is noted that the tubes are aligned with one another in a side-by-side, linear relation.

A “TEC” tube 40 is located alongside the three fluid transmission tubes 28,30,32. “TEC” is a term of art describing a conduit formed of flexible steel that contains a specialized electrical wiring 42 used to transmit signaling uphole from a device such as the sensor 24. A layer of steel armor 44 surrounds the fluid tubes 28, 30, 32 and the TEC tube 40. The armor 44 is preferably made of galvanized steel, monel or stainless, and is wrapped around the tubes. An optional filler 46 may be located between the armor layer and the tubes 28, 30, 32, 40. The filler 46 maybe an elastomeric or plastic material. The function of the filler 46 is to provide blocking between the tubes 28, 30, 32 and 40 and the armor 44. Thus, the fuller 46 helps to protect the tubes and provides a cushion between them and the armor layer 44.

An outer jacket 48 surrounds the metal armor layer 44. The jacket 48 provides an abrasion-resistant outer surface for the control cable 26. The jacket 48 is preferably extruded onto the armor layer 44 during production. The jacket 48 may be formed of an elastomeric thermoset material or a thermal plastic material. The preferred materials for the jacket include EPDM and nitrile rubber, which are elastomeric, thermoset materials preferred for use in high-temperature wellbores, and polypropylene or PVDF, which are thermoplastic materials preferred for use in lower temperature wellbores.

Referring once again to FIG. 1, it can be seen that the tubes within the control cable 26 are operationally interconnected for control or communication of various devices within the wellbore 10. The fluid transmission tube 28, for example, is operably interconnected with the packoff assembly 22 to selectively provide fluid for the actuation of the packoff assembly 22. It is noted that a portion of the outer jacket 48 and armor layer 44 will need to be removed in order to extract the fluid tube 28 from the control cable 26 and interconnect it with the packoff assembly 22. Fluid tubes 30 and 32, meanwhile, are operably associated with the fluid pump 20.

The TEC tube 40 is operably associated with the pressure sensor 24 so that signals indicative of wellbore pressure may be transmitted along the conductor 42 uphole.

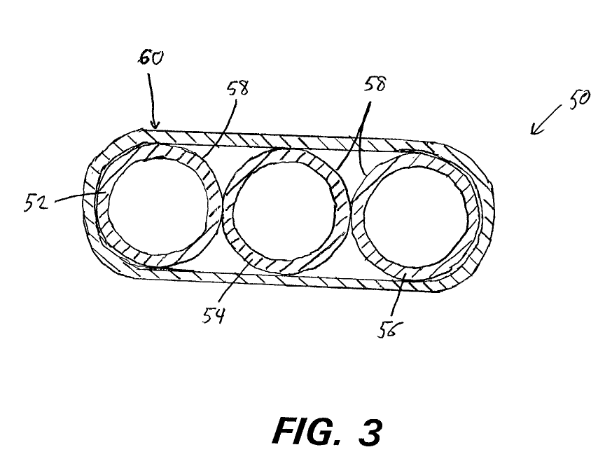

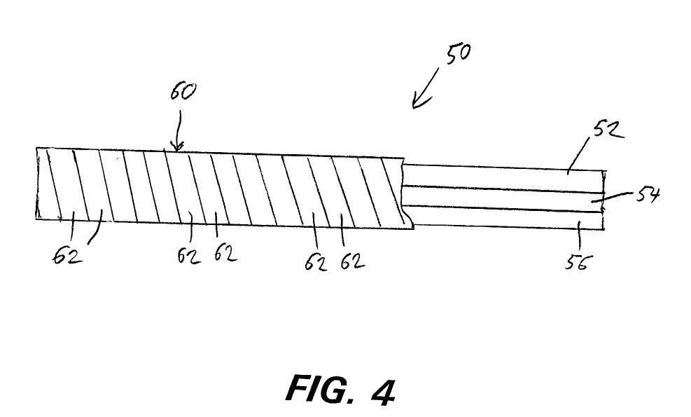

Referring now to FIGS. 3 and 4, an alternative, and currently preferred, embodiment for an armored cable 50 is depicted. The armored cable 50 depicted is used to transmit fluids and has three fluid transmission tubes 52,54,56, which are disposed in a side-by-side relation. Each of the tubes 52, 54 and 56 is elongated, cylindrical and presents a substantially round cross-section. The outer walls 58 of each of the tubes 52, 54, 56 are maintained in contact with the adjoining tube. No elastomeric or thermoplastic filler or packing material is disposed around the tubes 52, 54, 56 that might preclude this contact. Further, gases located within the armor layer 60 may escape more easily from the armor 60 when the cable 50 is decompressed since the gases will not become entrained within a layer of filler or packing material.

An armor layer 60 is wrapped around the three tubes and contacts the outer walls 58 of each. The armor layer 60 is formed of layers 62 of metal tape that are wound about the tubes 52, 54 and 56 in a spiral fashion, as FIG. 4 shows. There is no need for a thermoplastic cover or coating to surround the armor layer 60. Therefore, the outer surface of the armor layer presents the outer surface of the cable 50.

The cable 50 provides a number of operational advantages. Cost is minimized since no elastomeric or thermoplastic filler is required for manufacture of the cable 50. The cable 50 is also lightweight and simple in design. In addition, the cable 50 is physically strong and resistance to damage from external physical hazards.

It will be apparent to those skilled in the art that modifications, changes and substitutions may be made in the invention shown in the foregoing disclosure. Accordingly, it is appropriate that the appended claims be construed broadly and in the manner consisting with the spirit and scope of the invention herein.

What is claimed is:

1. A cable for transmitting fluid comprising:
three fluid flow tubes maintained in a side-by-side relation and in contact with one another;
and a metal armor jacket that surrounds each of the three tubes.

2. The cable of claim 1 wherein the metal armor jacket is maintained in contact with each of the three tubes.

3. The cable of claim 1 wherein the metal armor jacket comprises a spiral-wrapped armor layer.

4. The cable of claim 1 wherein each of the fluid tubes is cylindrical in shape.

5. The cable of claim 1 wherein the metal armor jacket presents an outer surface that forms the outer surface of the control cable.

6. A cable for use within a wellbore comprising:
a plurality of elongated fluid flow tubes, each of the fluid flow tubes having a substantially round cross section and being disposed in a substantially parallel relation and maintained in contact with one another; and
a outer armor jacket formed of metal that surrounds and contacts each of the flow tubes.

7. The cable of claim 6 wherein the outer armor jacket comprises a spiral-wrapped armor layer.

8. The cable of claim 6 wherein the flow tubes are aligned in a side-by-side relation.

9. The cable of claim 6 wherein each of the flow tubes has a substantially circular cross-section.

10. A cable for transmitting fluid comprising:
a plurality of fluid flow tubes disposed in a parallel and side-by-side linear relation and maintained in contact with one another; and
a single outer metal armor that surrounds each of the fluid flow tubes, the metal armor being formed of a plurality of winds of a metal tape.

11. The cable of claim 10 wherein there are three fluid flow tubes.

12. The cable of claim 10 wherein there is no thermoplastic or elastomeric filler within the outer metal armor.
